(19) United States
(12) Patent Application Publication
(10) Pub. No.: US 2015/0006224 A1
(43) Pub. Date: Jan. 1, 2015

(54) INFORMATION MEDIA ENHANCED SALES

(71) Applicant: International Business Machines Corporation, Armonk, NY (US)

(72) Inventors: Yoel Arditi, Petach Tikwa (IL); Norbert Herman, Denver, CO (US); Daniel T. Lambert, New York, NY (US)

(21) Appl. No.: 13/929,245

(22) Filed: Jun. 27, 2013

(51) Int. Cl. G06Q 10/06

(52) U.S. Cl. CPC G06Q 10/06313
USPC 705/7.23

(57) ABSTRACT

A computer system identifies an individual physically present at a location. With the individual's identity, the computer system retrieves information corresponding to the individual from one or more online sources. Based, at least in part, on the retrieved information, the computer system determines a sales approach specific to the individual. The computer system communicates the sales approach to a computing device capable of displaying the sales approach to a user.

### FIELD OF THE INVENTION

The present invention relates generally to the field of information technology and sales, and more particularly to the use of computer technology and information media used to create a sales approach for a specific customer.

### BACKGROUND OF THE INVENTION

The goal of most traditional brick and mortar retailers is to make an in-store sale in a quick, effective manner. Retailers typically desire customers to circulate in the store, look at items, compare them and make a product sale on site without leaving the premises. However, there is a growing trend in retail for “show rooming,” where a customer comes into the store to touch, see, and question sales employees on a product, but complete the purchase on-line where there may be a lower price. Storefront retailers continue to look for ways to get more people into their stores, to walk the aisles, to look at products and purchase.

### SUMMARY

Embodiments of the present invention include a method, computer program product, and system for providing network access. A computer system identifies an individual physically present at a location. With the individual's identity, the computer system retrieves information corresponding to the individual from one or more online sources. Based, at least in part, on the retrieved information, the computer system determines a sales approach specific to the individual. The computer system communicates the sales approach to a computing device capable of displaying the sales approach to a user.

### BRIEF DESCRIPTION OF THE SEVERAL VIEWS OF THE DRAWINGS

FIG. 1 is a functional block diagram of a distributed data processing environment in accordance with an embodiment of the present invention.

FIG. 2 is a flow chart depicting operational steps of a retail enablement program operating on a computer within the distributed data processing environment in accordance with an embodiment of the present invention.

FIG. 3 illustrates an example of a matrix of customer incentives used by a retail enablement program, operating on a computer within the data processing environment of FIG. 1 in accordance with an embodiment of the present invention.

FIG. 4 depicts a block diagram of components of the computer executing the retail enablement program, in accordance with an embodiment of the present invention.

### DETAILED DESCRIPTION

Embodiments of the present invention recognize that many retailers are currently fighting the “showroom” experience where customers view merchandise in store, but, use an online shopping channel to complete the purchase. Strategies to combat this trend include outfitting store employees with mobile devices, tablets and other technologies to better support the customer, installing equipment (e.g., order kiosks) enabling customers to do their own support or shopping by accessing online inventory of a specific size or color not available in store, and placing an immediate order. In some cases, stores have adopted mobile applications that enable assistance from a customer representative. While offering a whole set of services to every customer may be an effective inducement to create a sale, retailers realize that this is costly. Embodiments of the present invention provide a method to gauge a specific approach to take with each customer. More specifically, embodiments may provide a system to more intelligently create a positive customer experience that leads to an in store transaction. An exemplary embodiment of this invention proposes an effective mechanism to identify specific products to offer, level of customer service, and incentives to offer a specific, targeted customer to aide a retail associate in closing the sale. Embodiments of the present invention may gather and analyze customer specific data from social media sites, information sites, public databases, store databases, etc. This data can then be used to recommend a sales approach best suited to the customer, products to offer, and an incentive or “save” action targeted to the specific customer. This information may be relayed electronically to a customer service or retail sales associate.

Implementation of such embodiments may take a variety of forms, and exemplary implementation details are discussed subsequently with reference to the Figures.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

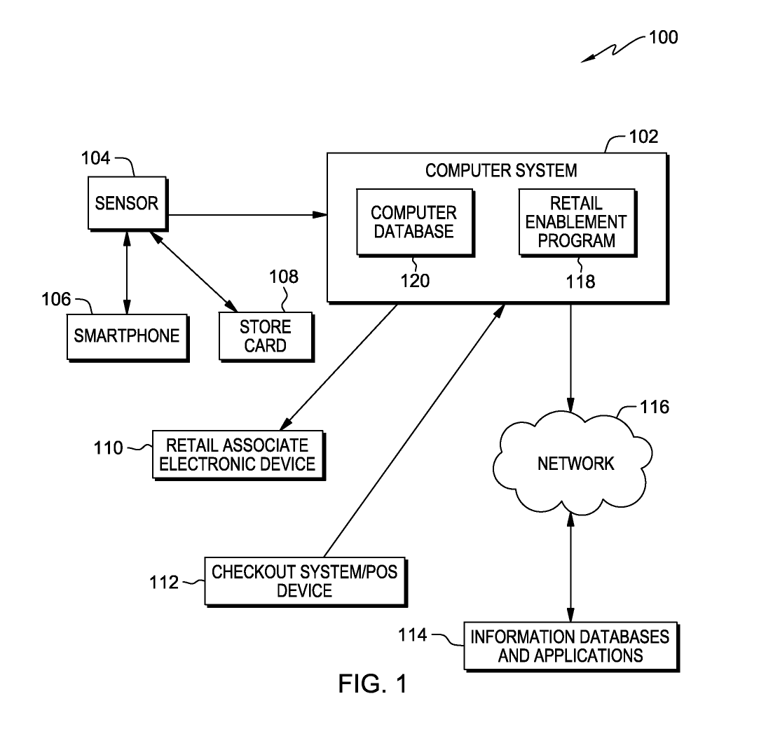

The present invention will now be described in detail with reference to the figures. FIG. 1 is a functional block diagram illustrating the elements of a distributed data processing environment, generally designated 100, in accordance with one embodiment of the present invention. This environment includes computer system 102 in communication with sensor device 104. Sensor device 104 may in turn communicate with a consumer device (i.e., a computing device owned by a potential customer), depicted here as smart phone 106 and store card 108. In one embodiment, computer system 102 is also communicatively coupled to an electronic device controlled by an employee, e.g., retail associate electronic device 110, and a store managed checkout system or point of sale device, e.g., checkout system 112. Computer system 102 may also communicate with various information databases and web applications 114 via network 116.

Network 116 can be, for example, a local area network (LAN), a wide area network (WAN) such as the Internet, or a combination of the two, and can include wired, wireless, or fiber optic connections. In general, network 116 can be any combination of connections and protocols that will support communications between computer system 102 and information databases and applications 114, which may be representative of social media sites like Facebook, Twitter, Instagram, Linkedin; applications like FourSquare, Shopkick, and QR; and information sites and databases like Google, Axciom, Bing and public records, for example.

Computer system 102 may be a server computer, a laptop computer, tablet computer, netbook computer, personal computer (PC), a desktop computer, or similar electronic device able to communicate with network 116, sensor device 104, checkout/POS device 112, and retail associate electronic device 110. In certain embodiments, computer system 102 represents a computer system utilizing clustered computers and components that act as a single pool of seamless resources when accessed through network 116. Computer system 102 includes retail enablement program 118.

Retail enablement program 118 can access network 116 to access information databases and applications 114. Information databases and applications 114 may be representative of social media sites (e.g., Facebook, Linkedin, Twitter, Instagram), web applications (e.g., FourSquare, QR, shopkick, Klout), information and search sites (e.g., Google and Bing), and records available online (e.g., store records and available public records such as real estate transactions, birth announcements, weddings).

In one embodiment, sensor device 104 helps identify a customer by accessing an electronic consumer device of the customer having identification information, e.g., Smartphone 301 or store card 302. Sensor device 104 may, in one embodiment, utilize RFID or other wireless communication protocol to communicate with the electronic consumer device.

Retail associate electronic device 110 may be a handheld electronic device, PDA, smartphone, or static electronic device, like an interactive checkout device, that allows a sales associate to receive and send information to a store computer system, e.g., computer system 102. Retail associate electronic device 110 may receive from retail enablement program 118 a list of products to offer, a recommended approach for a customer, and incentives to offer a customer. A sales associate or other checkout assistant may use checkout/POS device 112 to complete the sale. Checkout/POS device 112 may record purchase information to computer system 102. Customer database 120 on computer system 102 may store purchase information (e.g., approach used, products purchased, incentives offered) in association with an identity of the customer.

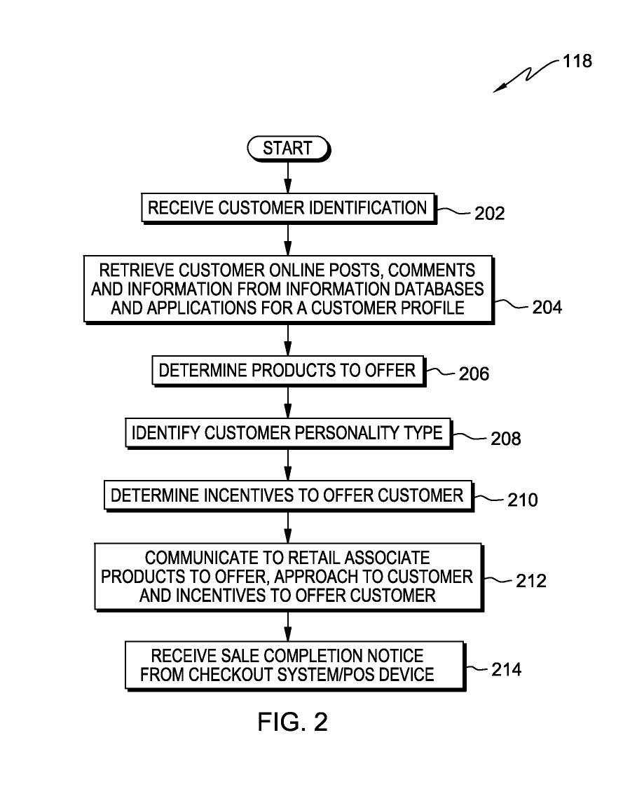

FIG. 2 is a flowchart depicting operational steps of retail enablement program 118 in accordance with an embodiment of the present invention. While steps of retail enablement program 118 are depicted in an illustrated order, they are not necessarily limited to being performed in the illustrated order. Some steps may be performed simultaneously or before or after the shown order (for example, step 210 may be performed before step 206).

In step 202, retail enablement program 118 receives a customer's identification from sensor device 104, store customer database 120, or from retail associate electronic device 110. In one embodiment, customer store card 302 can be directly read by sensor device 104 upon entry into the store. In another embodiment, a sales associate may ask the customer their name and enter the name into retail associate electronic device 110. Sensor device 104, or retail associate electronic device 110, may subsequently forward the identification information to retail enablement program 118. Customer name, address, and e-mail address may be stored in customer database 120 from previous purchases or store card registration. Sensor device 104 may also alert retail enablement program 118 of a customer's entry into the store when a customer or a friend in the area clicks or activates location applications such as Foursquare, QR, Shopkick and similar apps for a customer's cell phone, PDA or similar electronic device. In addition, Shopkick, QR, Foursquare and similar applications may also provide Facebook, Twitter, e-mail and/or other account user names which may be relayed to computer system 102. Various programs can bridge a customer's name, address and e-mail to a Facebook, Instagram or Twitter account. Customer images may also be available on Facebook, Instagram, etc., that can be sent by retail enablement program 118 to retail associate electronic device 110 so that a sales associate may confirm customer identification. In yet another embodiment, sensor device 104 may receive images of an incoming customer (for example, sensor device 104 may be a camera) and forward the images to computer system 102. Computer system 102 may use facial recognition, utilizing sources like Facebook, to identify the customer.

In step 204, retail enablement program 118 searches information databases and applications 114 to build a customer profile. For example, retail enablement program 118 may import online posts from social media sources like Facebook, Twitter, Instagram and Linkedin. Online posts gathered by retail enablement program 118 can identify immediate customer wants or needs directly by comments such as “Getting a new laptop for my son.”

In addition to looking at information databases and applications 114, retail enablement program 118 may access traditional customer purchase history, including previous purchases, extended warranty use, volume, and frequency of purchases from customer database 120. Retail enablement program 118 may also search information sites and databases like Google, Bing, and public databases for life events for such as weddings, birth announcements, house purchases (deed transfers). Identified life events may be incorporated into a customer profile.

In step 206, retail enablement program 118 determines a list of products to offer a customer. Using the information gathered from information databases and applications 114, a list of customer likes, needs, and wants may be compiled. Customer wants and needs can be identified directly from online posts on social media sites such as Facebook, Twitter, and Instagram. For example, on line posts such as “Time for a new TV.”; “The car is in the shop again! I'm getting a new SUV.” or “I love the new Jimmy Choo shoes!” can be used to directly identify some of a customer's immediate needs/wants and products that could be offered. Retail enablement program 118 may search online posts for key words such as “new”, “I need”, “I want”, “buying”, “getting”, “purchasing”, for example, to compile a list of products of interest for the specific customer. Additionally, retail enablement program 118 may initiate a search of public records or Google search to reveal life events such as a new home purchase. The purchase of a new house indicates potential opportunities for home product sales associated with new home ownership such as personalization (paint), upgrades (granite counter tops), new rugs, appliances (oven, stove, washer/dyer, air conditioning). Additional life events can include marriage, births, house purchase and other significant changes to lifestyle. Potential purchases driven by these events may be included in retail enablement program 118. For example, a birth record could trigger addition of a crib, diapers and strollers to the list of products for parents listed in the birth record.

In addition, a review of previous store purchases, as provided from customer database 120, can be used by retail enablement program 118 to generate a recommended product offering. For example, accessing the data from customer database 120 may show a customer has purchased product A and B. In response, retail enablement program 118 may suggests offering product C. Another customer may have a history of purchasing action movies. Retail enablement program 118 may recommend an offer of the newest action movie not purchased by the customer. Retail enablement program 118 may also include supporting information on recommended products including the answers to frequently asked questions (FAQ) on these products when available.

In step 208, retail enablement program 118 develops a customer personality profile. Retail enablement program 118 may perform a detailed customer personality profile analysis using online posts and the customer's comments on information and social media sites. Online posts and comments may be gathered from Facebook, Twitter, Instagram, and Linkedin to be analyzed for personality type identification. Retail enablement program 118 can use psycholinguistic frequency, word counting and other text analytics for customer personality profiling.

In one embodiment, retail enablement program 118 uses psycholinguistic analysis of text within messages or online posts that have been pulled into the customer profile to create easily understandable customer personality profiles or personality types using known psychological profiling methods. Personality types are used by retail enablement program 118 to generate a recommended level of customer interaction or approach employed by a sales associate. The personality types can also be used to develop recommended incentives to best match a customer.

In one exemplary embodiment of the present invention, the psycholinguistic frequency of phrases within text can be used by retail enablement program 118 to categorize people into personality types. Using commonly used psychological personality types such as amiable, driver, expressive and analytical, for example, key words can be identified that are a part of a preferred communication style for a personality type. The frequency of the use of these words for a specific personality type can be used to identify a customer's personality type. For example, one of these common personality types is an amiable. Amiables are focused on people. They are sensitive to other's feelings, patient, nurturing and relationship driven. Identifying an amiable through the use of online posts, retail enablement program 118 would look for a high percentage of posts or keyword frequency using words like friends, like, love, hangout, together or phrases like “How are you . . . ?,” “Would you like to . . . ?,” “Let's get together,” or “What do you think?” Amiables tend to use non-aggressive, nurturing language. Sentence structure reflecting nurturing, non-aggressive language with phrases as shown above for example can be used to help identify an amiable personality type. Posts with a high degree of aggressive language like “Let's eat now,” “We need to go to the mall,” “That's not the way to . . . ,” “OMG! You've got to be kidding me!,” and using words like “must”, “now,” and “I want,” for example, would not be a preferred match for an amiable personality type.

In exemplary embodiments of the present invention, a sales approach for a customer can be recommended by retail enablement program 118 based on an identified personality type. For example, retail enablement program 118 could recommend a customer identified as an amiable be approached using a high touch customer approach emphasizing personal, one-on-one service, and that stresses how the product or services offered are helpful to family members or friends. In another example, a customer identified as an analytical could best be approached in a low key, factual method that discusses product specs, product attribute, and comparative product reviews in trade publications. In some cases, retail enablement program 118 may indicate little or no customer interaction.

In one exemplary embodiment of the present invention, an improved compatibility match of a sales associate to a specific customer may be attained using a customer personality profile and an array of attributes about a sales associate. A customer with a personality type determined by retail enhancement program 118 can be matched to a sales associate with a similar personality type. This can be done at the psycholinguistic level through word category counting, matching or through more broad personality matching. This feature could be extremely relevant in high end fashion sales where the right sales associate can double or triple a customer's purchase.

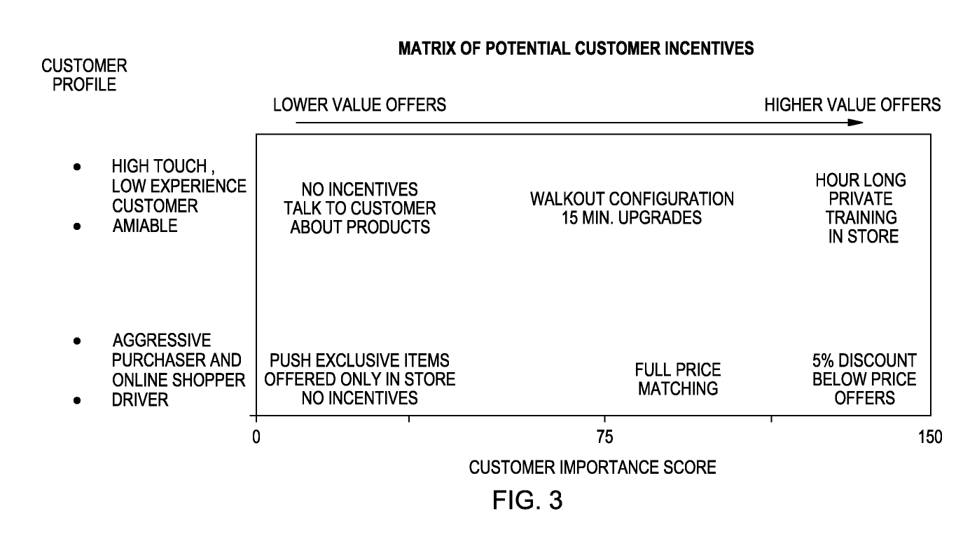

In step 210, retail enablement program 118 determines the best “save” action or customer specific incentive to make sure that the customer completes the sale. Based on the customer's profile, personality profile, the size of the purchase being considered, and the customer's influence, a recommended allowable incentive maybe sent by retail enablement program 118 to a sales associate (via retail associate electronic device 110) to offer a customer. Examples of potential incentives to offer a customer could include golf club covers for a set of golf clubs, extended warranty for a customer indicating an interest in warranties making a significant purchase or a 4G (small) memory card for the purchase of a moderate camera ($200-400). In one example, one measure of customer influence could be developed using Klout. Klout is a website and mobile application that uses social media analytics to rank its users according to online social influence via a “Klout Score,” which is a numerical rating between 1 and 100. Retail enablement program 118 may consider a mix of factors, such as product or service being considered, purchase history, purchase size, customer influence, customer profile and personality type to automatically pull from a predefined list of incentives. For example, FIG. 3 illustrates one possible matrix of customer incentives used by retail enablement program 118. The matrix of incentives to offer a customer can be put into a structured database. The matrix is developed using an identified customer personality profile and customer importance. In this embodiment of the present invention, a customer importance score calculated by an algorithm using Klout score, size of the purchase being considered and the customer purchase history (e.g., annual store customer spending). The following table illustrates an example of a customer importance score calculation:

| Klout | | Purchase | | Annual | |
|---|---|---|---|---|---|
| Score | CI1 | value | CI2 | purchase | CI3 |
| >30 | 10 | <$50 | 10 | <$200 | 5 |
| 30-50 | 20 | $51-150 | 20 | $201-$1500 | 10 |
| 51-75 | 30 | $151-250 | 30 | $1501-3000 | 20 |
| 76-89 | 40 | $251-$2000 | 40 | $3001-5000 | 30 |
| 90-100 | 50 | >$2000 | 50 | >5000 | 40 |

where CI1, CI2, CI3 are elements of the customer importance score and CI1 is the customer importance score element related to a customer' Klout score. CI2 is the customer importance score element for the current purchase and CI3 is the customer importance score element related to a customer's annual store purchase. The customer importance could be calculated by adding CI1+CI2+CI3. For example, if a customer has a Klout score of 55, and is considering a purchase of a $200 camera in a store where their annual store purchase total is $2000, the resulting customer importance score would be 75 (30+30+15).

A matrix of incentives may be put into a structured database that can be plotted as illustrated in FIG. 3. This database is used to graph recommended incentives to offer a customer based on the customer's profile and customer importance score. For example, a high touch, low experience customer with an amiable personality type, and with a customer importance score of 75 could be offered an incentive of a 15 minute computer software upgrade for a computer purchase. An example of incentives to offer a customer with a similar customer profile; amiable, high touch, low experience but, with a higher customer importance score driven by a higher value purchase of a home theater system and larger annual purchase (>$5000), could be a 30-60 minute tutorial on best theater set-up and features. The value of the incentive offered can increase with increasing customer importance. In additionally, the type of incentive offered could change depending on the customer profile. For example, a high touch, amiable could be offered more sales associate time and training while a more aggressive, online shopper may be offered lower price or additional features. This approach applies a customer profile to an objective numerical scoring methodology to determine a pre-set incentive to offer a targeted customer. Retail enablement program 118 may allow a sales associate to enter the customer's reaction to the offer in the customer notes section of the program. Feedback may be entered directly into computer system 102 or into retail associate electronic device 110 in various embodiments. The feedback may be utilized in the solution and analyzed in order to improve retail enablement program 118's success rate. The feedback may further be used to train sales associates on the best way to engage with customers.

In step 212, retail enablement program 118 communicates to a sales associate the recommendations generated based on the analysis performed. The recommendations may include a list of products to offer, a suggested customer approach for a customer, and recommended incentives for the customer. In one embodiment, these recommendations are communicated electronically from retail enablement program 118 to retail associate electronic device 110, which may be a PDA, netbook, smartphone, computer device or handheld mobile device that can output directly to the sales associate. The sales associate may then use this information to interact with the customer and suggest products and indicated incentives as needed to the identified customer in order to complete an in-store sale.

In step 214, a sales associate or assistant may enter sale completion into checkout system/POS device 112, which in turn may automatically update customer database 120. In addition, the sales associate may have the ability to add comments/feedback on sales interaction into retail enablement program 118 through retail associate electronic device 110 or checkout/POS device 112. This information can be added to the customer's profile for future interactions and analysis.

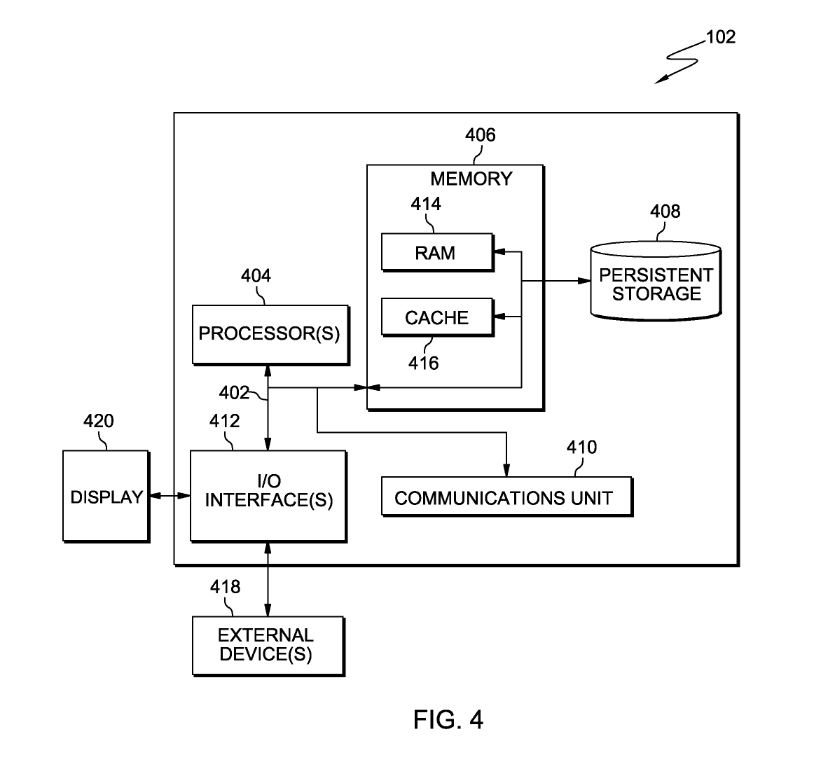

FIG. 4 depicts a block diagram of components of computer system 102 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computer system 102 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Retail enablement program 118 is stored in persistent storage 408 for execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including smartphone 106, store card 108, retail associate electronic device 110, checkout/POS device 112, and information databases and applications via network 116. In these examples, communications unit 410 includes one or more network interface cards. Communications unit 410 may provide communications through the use of either or both physical and wireless communications links. Retail enablement program 118 may be downloaded to persistent storage 408 through communications unit 410.

I/O interface(s) 412 allows for input and output of data with other devices that may be connected to computer system 102. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., retail enablement program 118, can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method to develop a targeted sales approach, the method comprising:
identifying an individual physically present at a location;
retrieving, by one or more computer processors, information corresponding to the individual from one or more online sources;
determining, by one or more computer processors, a sales approach specific to the individual; and
communicating the sales approach to a computing device capable of presenting the sales approach.

2. The method of claim 1, wherein retrieving information corresponding to the individual comprises identifying, from the one or more online sources, one or more of: online comments;
online ratings; and purchase history.

3. The method of claim 1,
wherein determining the sales approach specific to the individual comprises analyzing, by one or more computer processors, the retrieved information by key words indicating products of interest to the individual; and
wherein communicating the sales approach by the computing device comprises notifying a user of the products of interest to the individual.

4. The method of claim 1, wherein determining the sales approach specific to the individual comprises:
analyzing online comments from the one or more online sources; and
determining a personality profile, including an identified personality type, based on the analyzing.

5. The method of claim 4, further comprising: determining a level and a type of interaction to be taken with the individual by using the personality profile.

6. The method of claim 1, wherein determining the sales approach specific to the individual comprises:
determining one or more incentives for the individual, based on one or more of: personality profile; products of interest; amount of social media activity; and purchase history.

7. The method of claim 1, wherein determining a sales approach specific to the individual comprises:
determining a customer importance score; and
determining one or more incentives to offer the customer by using customer importance score, a customer profile and personality type.

8. A computer program product for developing a targeted sales approach, the computer program product comprising:
one or more computer-readable storage media and program instruction stored on the one or more computer-readable storage media, the program instructions comprising:
program instructions to identify an individual physically present at a location;
program instructions to retrieve, by one or more computer processors, information corresponding to the individual from one or more online sources;
program instructions to determine, by one or more computer processors, a sales approach specific to the individual; and
program instructions to communicate the sales approach to a computing device capable of presenting the sales approach.

9. The computer program product of claim 8, wherein the program instructions to wherein retrieve information corresponding to the individual comprises identifying, from the one or more online sources, one or more of: online comments; online ratings; and purchase history.

10. The computer program product of claim 8,
wherein the program instructions to determine the sales approach specific to the individual comprises analyzing, by one or more computer processors, the retrieved information by key words indicating products of interest to the individual; and
wherein communicating the sales approach by the computing device comprises notifying a user of the products of interest to the individual.

11. The computer program product of claim 8, wherein the program instructions to determine the sales approach specific to the individual comprises:
analyzing online comments from the one or more online sources; and
determining a personality profile, including an identified personality type, based on the analyzing.

12. The computer program product of claim 8, further comprising program instructions, stored on the one or more computer-readable storage media, to determine a level and a type of interaction to be taken with the individual by using the personality profile.

13. The computer program product of claim 8, wherein the program instructions to determine the sales approach specific to the individual comprise program instructions to determine one or more incentives for the individual, based on one or more of: personality profile; products of interest; amount of social media activity; and purchase history.

14. The computer program product of claim 8, wherein the program instructions to determine a sales approach specific to the individual comprises:
determining a customer importance score; and
determining one or more incentives to offer the customer by using customer importance score, a customer profile and personality type.

15. A computer system to develop a targeted sales approach, the computer system comprising:
one or more computer processors;
one or more computer-readable storage media;
program instructions stored on the computer-readable storage media for execution by at least one of the one or more computer processors, the program instructions comprising:
program instructions to identify an individual physically present at a location;
program instructions to retrieve by one or more computer processors, information corresponding to the individual from one or more online sources;
program instructions determine, by one or more computer processors, a sales approach specific to the individual; and
program instructions to communicate the sales approach to a computing device capable of presenting the sales approach.

16. The computer system claim of 15, wherein the program instructions to retrieve information corresponding to the individual comprises, program instructions to identify, from one or more sources, one or more of: online comments, online ratings, and purchase history.

17. The computer system claim of 15,
wherein the program instructions to determine the sales approach specific to the individual comprise program instructions to analyze the retrieved information by key words indicating of products of interest to the individual; and
wherein the program instructions to communicate the sales approach by the computing device comprises program instructions to notify a user of the products of interest to the individual.

18. The computer system claim of 15, wherein the program instructions to determine the sales approach specific to the individual comprise program instruction to:
analyze online comments from the one or more online sources; and
determine a personality profile, including an identified personality type, based on the analysis.

19. The computer system claim of 15, wherein the program instructions to determine the sales approach specific to the individual comprise program instruction to:
analyze online comments from the one or more online sources; and
determine a personality profile, including an identified personality type, based on the analysis.

20. The computer system claim of 15, wherein the program instructions to determine a sales approach specific to the individual comprise program instructions to determine a customer importance score, and
determine one or more incentives to offer the customer using customer importance score, a customer profile and personality type.
